(19) United States
(12) Patent Application Publication
(10) Pub. No.: US 2010/0227224 A1
(43) Pub. Date: Sep. 9, 2010

(54) HIGH PERFORMANCE SULFUR-BASED DRY POLYMER ELECTRODES

(75) Inventors: Hany Basam Eitouni, Oakland, CA (US); Mohit Singh, Berkeley, CA (US)

Correspondence Address: SEEO, INC., 626 BANCORFT WAY, SUITE 3B, BERKELEY, CA, 94710, US

(73) Assignee: SEEO, INC, Berkeley, CA (US)

(21) Appl. No.: 12/718,602

(22) Filed: Mar. 5, 2010

Related U.S. Application Data
(60) Provisional application No. 61/158,329, filed on Mar. 6, 2009.

(51) Int. Cl. H01M 6/18

(52) U.S. Cl. 429/322; 429/304

(57) ABSTRACT

A sulfur-based cathode for use in an electrochemical cell is disclosed. An exemplary sulfur-based cathode is coupled with a solid polymer electrolyte instead of a conventional liquid electrolyte. The dry, solid polymer electrolyte acts as a diffusion barrier for the sulfur, thus preventing the sulfur capacity fade that occurs in conventional liquid electrolyte based cell systems. The solid polymer electrolyte further binds the sulfur-containing active particles, preventing sulfur agglomerates from forming, while still allowing lithium ions to be transported between the anode and cathode.

### CROSS-REFERENCE TO RELATED APPLICATIONS

This application claims priority to U.S. Provisional Patent Application 61/158,329, filed Mar. 6, 2009, which is incorporated by reference herein.

### BACKGROUND

The demand for rechargeable batteries has grown by leaps and bounds as the global demand for technological products such as cellular phones, laptop computers and other consumer electronic products has escalated. In addition, interest in rechargeable batteries has been fueled by current efforts to develop green technologies such as electrical-grid load leveling devices and electrically-powered vehicles, which are creating an immense potential market for rechargeable batteries with high energy densities.

Li-ion batteries are some of the most popular types of rechargeable batteries for portable electronics. Li-ion batteries offer high energy and power densities, slow loss of charge when not in use, and they do not suffer from memory effects. Because of many of their benefits, including their high energy density, Li-ion batteries have also been increasingly used in defense, aerospace, back-up storage, and transportation applications.

Despite the push for better performance and lower cost in lithium ion batteries, there has been little change to the basic architecture of lithium ion cells, and in particular, little change to design of cell electrodes. A porous electrode active film has electrode active material particles and conductive particles bound together with polymer binder. This film is usually deposited onto a metallic current collector. Liquid electrolyte is soaked into the porous film. The pores ensure that there is a large surface area for charge transfer between the electrode active material and the liquid electrolyte.

Lithium-sulfur couples have been studied as they have the potential to produce batteries with higher capacity and higher energy than conventional Li-ion batteries. However, there are many problems and lithium-sulfur systems have not been very useful. One problem is that sulfur is very soluble in typical liquid electrolytes. In a conventional sulfur-based electrochemical cell system, the sulfur in the cathode (in the form of polysulfides, for example) dissolves in the electrolyte and diffuses to the anode where it reacts with the lithium to form lithium sulfides. Trapped at the anode in the reduced state, the sulfur cannot be reoxidized to the original form and be returned to the cathode. This leads to rapid capacity fade, resulting ultimately in cell death.

Another problem associated with lithium-sulfur systems arises from loss of surface area in the electrodes. During cycling, sulfur in the electrode region aggregates into larger particles, permanently changing the morphology of the cathode. The change in morphology results in reduced ionic and electronic conductivity. Thus it has not been possible to produce viable battery systems from lithium-sulfur couples.

It would be useful to construct a battery in which sulfur could be used as the active cathode material in order to exploit the high capacity and high energy that sulfur can provide.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 is a schematic drawing of a conventional electrode for an electrochemical cell.

FIG. 2 is a schematic drawing of an electrochemical cell that has one novel electrode and one conventional electrode, according to an embodiment of the invention.

FIG. 3 is a schematic drawing of an electrochemical cell that has two novel electrodes, according to an embodiment of the invention.

FIG. 4 is a schematic drawing of a diblock copolymer and a domain structure it can form, according to an embodiment of the invention.

FIG. 5 is a schematic drawing of a triblock copolymer and a domain structure it can form, according to an embodiment of the invention.

FIG. 6 is a schematic drawing of a triblock copolymer and a domain structure it can form, according to another embodiment of the invention.

### DETAILED DESCRIPTION OF THE EMBODIMENTS OF THE INVENTION

The disclosure herein relates generally to design of electrodes in batteries. More specifically, embodiments of the invention provide for a lithium-sulfur electrode couple that offers enhanced energy and increased power capabilities.

The effectiveness of the sulfur-based electrode system disclosed herein is because the polymer-based electrolyte material acts both as a barrier for sulfur diffusion and as a inhibitor of sulfur aggregation, thus overcoming some of the most important problems with lithium-sulfur batteries in the past. Such a battery with a sulfur-based electrode offer enhanced energy and power capabilities. Sulfur-containing cathodes coupled with lithium-containing anodes in a solid polymer based electrolyte can produce an electrochemical cell that can be cycled extensively without capacity fade.

An exemplary sulfur-based cathode is coupled with a solid polymer electrolyte instead of a conventional liquid electrolyte. The dry, solid polymer electrolyte acts as a diffusion barrier for the sulfur, thus preventing the sulfur capacity fade that occurs in conventional liquid electrolyte based cell systems. The solid polymer electrolyte further binds the sulfur-containing active particles, preventing sulfur agglomerates from forming, while still allowing lithium ions to be transported between the anode and cathode.

In general, a solid polymer electrolyte based lithium-sulfur electrochemical cell can be adapted to increase current collector utilization, trim down inactive weight and volume, and cut down manufacturing costs, providing for long cycle life and high sulfur utilization.

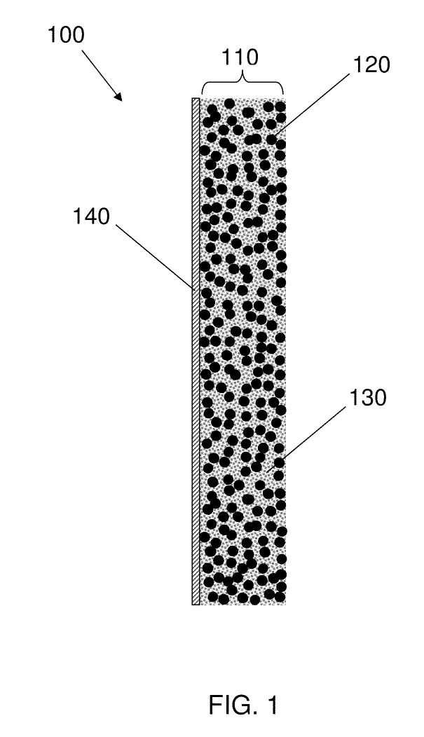

FIG. 1 is a cross-sectional schematic drawing of an electrode assembly 100 that includes an electrode film 110 and a current collector 140, according to an embodiment of the invention. The electrode film 110 has sulfur-containing electrode active material particles 120 embedded in a matrix of solid polymer electrolyte 130 that also contains small, electronically-conductive particles (as indicated by small grey dots) such as carbon black. The sulfur-containing (cathode) materials can be used in electrochemical cells having lithium or sodium anodes. Examples of sulfur-containing cathode materials include, but are not limited to elemental sulfur, organo-sulfur, and carbon-sulfur compositions. The solid polymer electrolyte 130 can be a polymer, a copolymer, or a blend thereof. In one arrangement, the solid polymer electrolyte 130 is a block copolymer electrolyte. In one arrangement, no additional binder material is added; the electrolyte 130 binds together the electrode active particles and the electronically-conductive particles and provides sufficient mechanical integrity to the electrode film 110. The block copolymer electrolyte 130 includes an ionically-conductive phase and a structural phase so that overall the block copolymer electrolyte has a modulus greater than about 1×10⁵ Pa at 25° C. In some arrangements, the block copolymer electrolyte 130 has a modulus greater than about 1×10⁶ Pa at 25° C. In some arrangements, the block copolymer electrolyte 130 has a modulus greater than about 1×10⁷ Pa at 25° C. In another arrangement, the electrode film 110 contains a small amount of an additional binder material, such as poly(vinylidene fluoride) or other fluorinated polymers to add strength to the film 110.

When a solid polymer electrolyte 130 is used, the electrolyte 130 cannot leak out of the electrode film 110, and there is no need for the current collector 140 to act as a barrier to hold liquid electrolyte within the electrode film 110. In some embodiments of the invention, the electrode film 110 has sufficient mechanical integrity to be freestanding. This makes it possible to use a very thin or reticulated metal current collector, whose only function is electronic conduction, thus reducing unnecessary weight and volume in the electrode assembly 100. Exemplary current collectors include aluminum and copper.

In one embodiment, a sulfur cathode is prepared in a similar manner to conventional cathodes. A sulfur-based active material is mixed with the carbon black. Examples of sulfur-containing cathode materials include, but are not limited to elemental sulfur, organo-sulfur, and carbon-sulfur compositions. The process includes intimate mixing, which can be achieved either by high energy ball milling or by heating the mixture above the melting point of sulfur. The process includes adding the mixture to a solution of solid polymer (e.g., block copolymer) electrolyte and salt in an appropriate solvent, such as NMP. The process includes sonicating and homogenizing the solution to ensure an even distribution of all the ingredients. The process includes casting a solution mixture onto a metallic current collector such as aluminum. In other embodiments, preparation of the sulfur cathode can involve other techniques, such as vapor deposition, compression molding, or extrusion. To form an electrochemical cell, the cathode is dried and interfaced with a layer of electrolyte and an anode, such as one containing lithium or sodium.

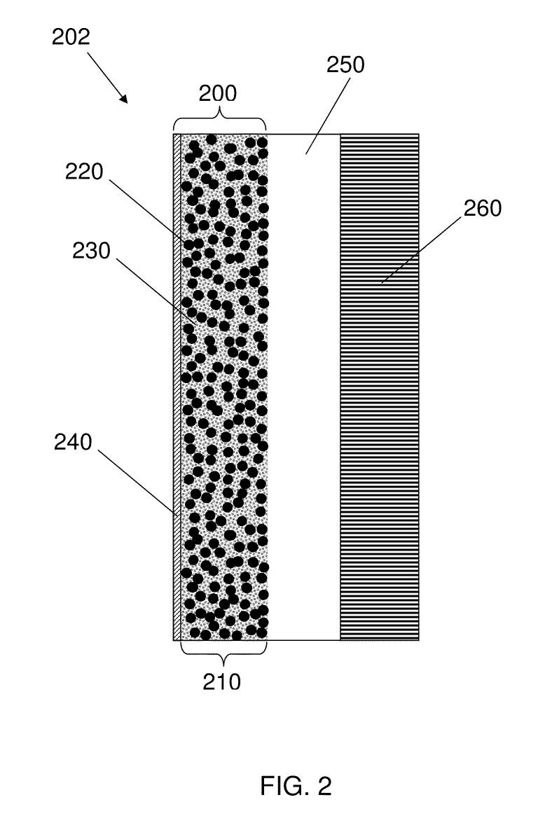

FIG. 2 is a cross-sectional schematic drawing of an electrochemical cell 202 with a positive electrode assembly 200 as described above in FIG. 1, according to an embodiment of the invention. The positive electrode assembly 200 has a positive electrode film 210 and a current collector 240. The positive electrode film 210 has positive electrode sulfur-containing active material particles 220 embedded in a matrix of solid electrolyte 230 that also contains small, electronically-conductive particles (as indicated by small grey dots) such as carbon black. The solid polymer electrolyte 230 can be a polymer, a copolymer, or a blend thereof. In one arrangement, the solid polymer electrolyte 230 is a block copolymer electrolyte. There is a positive electrode current collector 240 that may be a continuous or reticulated metal film as described above. There is a negative electrode 260 that is a metal layer, such as a lithium or sodium layer, that acts as both negative electrode active material and negative electrode current collector. In one arrangement (not shown), the negative electrode is a negative electrode assembly that includes a reticulated film of negative electrode material covered with a solid polymer electrolyte. The solid polymer electrolyte may or may not be the same as the solid polymer electrolyte 230 in the positive assembly 200. There is a separator region 250 filled with an electrolyte that provides ionic communication between the positive electrode film 210 and the negative electrode 260. In one arrangement, the separator region 250 contains a solid electrolyte and can be the same solid electrolyte (without the carbon particles) as is used in the positive electrode film 210 and/or in the negative electrode assembly.

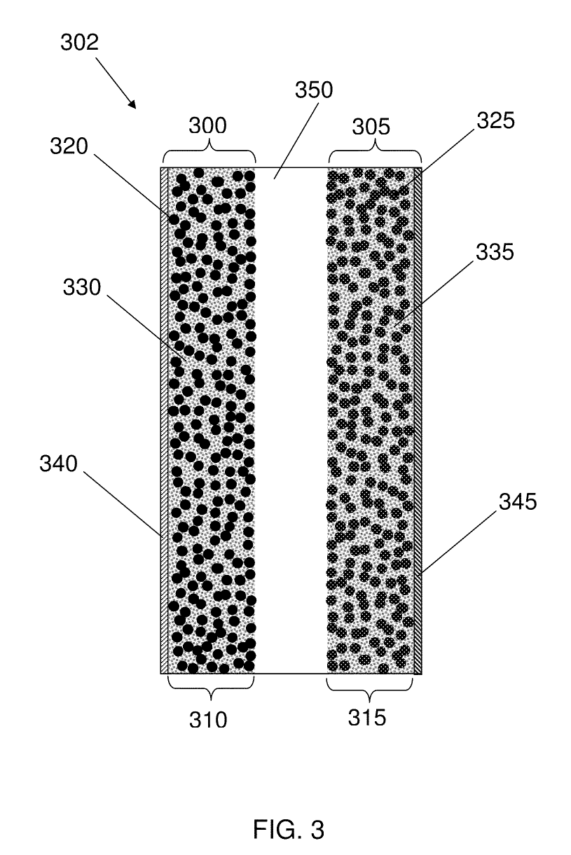

FIG. 3 is a cross-sectional schematic drawing of an electrochemical cell 302 with both a positive electrode assembly 300 and a negative electrode assembly 305 as described above FIG. 1, according to an embodiment of the invention. The positive electrode assembly 300 has a positive electrode film 310 and a current collector 340. The positive electrode film 310 has positive electrode sulfur-containing active material particles 320 embedded in a matrix of solid polymer electrolyte 330 that also contains small, electronically-conductive particles (as indicated by small grey dots) such as carbon black. The solid polymer electrolyte 330 can be a polymer, a copolymer, or a blend thereof. In one arrangement, the solid polymer electrolyte 330 is a block copolymer electrolyte. There is a positive electrode current collector 340 that may be a continuous or reticulated metal film as described above. The negative electrode assembly 305 has a negative electrode film 315 and a current collector 345. The negative electrode film 315 has negative electrode active material particles 325 embedded in a matrix of solid polymer electrolyte 335 that also contains small, electronically-conductive particles (as indicated by small grey dots) such as carbon black. The solid polymer electrolyte 335 can be a polymer, a copolymer, or a blend thereof. In one arrangement, the solid polymer electrolyte 335 is a block copolymer electrolyte. The electrolytes 330, 335 may or may not be the same. There is a negative electrode current collector 345 that may be a continuous or reticulated metal film as described above. There is a separator region 350 filled with an electrolyte that provides ionic communication between the positive electrode film 310 and the negative electrode film 315. In one arrangement, the separator region 350 contains a solid electrolyte and can be the same solid electrolyte (without the carbon particles) as is used in the positive electrode film 310 and/or in the negative electrode film 315.

The relative ratios of the material components used in a sulfur-containing electrode can be varied for specific applications. In one embodiment, an exemplary electrode active film includes 50% to 80% sulfur, 15% to 20% carbon black, and 10% to 35% block copolymer. In one arrangement, the electronically conducting agent the cathode is acetylene black or other carbon as is known in the art. In one arrangement, the cathode current collector has a thickness less than about 10 microns. In another arrangement, the cathode current collector has a thickness less than about 5 microns. The current collector can have the form of a grid, a mesh, or a semi-continuous film.

In one embodiment of the invention, the cathode does not include any poly(vinylidene fluoride). In one arrangement, the cathode does not include any fluorinated polymers.

### Nanostructured Block Copolymer Electrolytes

As described in detail above, a block copolymer electrolyte can be used in the embodiments of the invention.

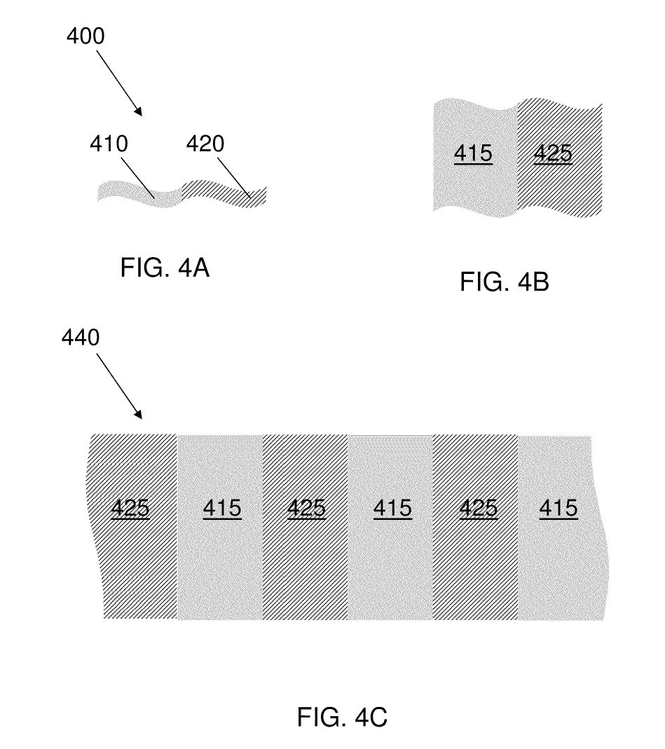

FIG. 4A is a simplified illustration of an exemplary diblock polymer molecule 400 that has a first polymer block 410 and a second polymer block 420 covalently bonded together. In one arrangement both the first polymer block 410 and the second polymer block 420 are linear polymer blocks. In another arrangement, either one or both polymer blocks 410, 420 has a comb (or branched) structure. In one arrangement, neither polymer block is cross-linked. In another arrangement, one polymer block is cross-linked. In yet another arrangement, both polymer blocks are cross-linked.

Multiple diblock polymer molecules 400 can arrange themselves to form a first domain 415 of a first phase made of the first polymer blocks 410 and a second domain 425 of a second phase made of the second polymer blocks 420, as shown in FIG. 4B. Diblock polymer molecules 400 can arrange themselves to form multiple repeat domains, thereby forming a continuous nanostructured block copolymer material 440, as shown in FIG. 4C. The sizes or widths of the domains can be adjusted by adjusting the molecular weights of each of the polymer blocks.

In one arrangement the first polymer domain 415 is ionically conductive, and the second polymer domain 425 provides mechanical strength to the nanostructured block copolymer.

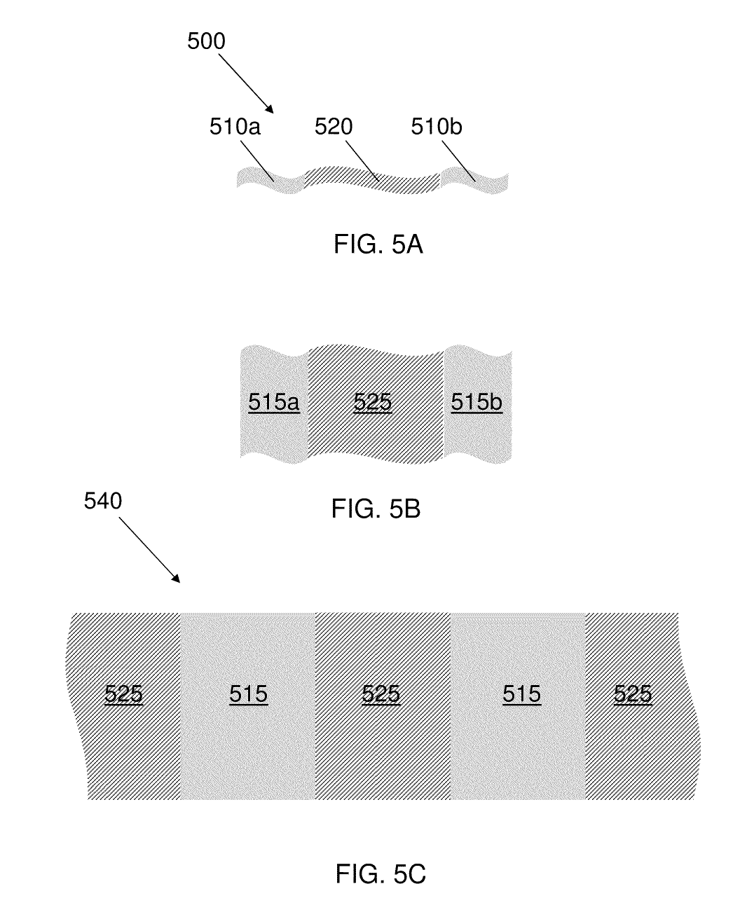

FIG. 5A is a simplified illustration of an exemplary triblock polymer molecule 500 that has a first polymer block 510a, a second polymer block 520, and a third polymer block 510b that is the same as the first polymer block 510a, all covalently bonded together. In one arrangement the first polymer block 510a, the second polymer block 520, and the third copolymer block 510b are linear polymer blocks. In another arrangement, either some or all polymer blocks 510a, 520, 510b have a comb (or branched) structure. In one arrangement, no polymer block is cross-linked. In another arrangement, one polymer block is cross-linked. In yet another arrangement, two polymer blocks are cross-linked. In yet another arrangement, all polymer blocks are cross-linked.

Multiple triblock polymer molecules 500 can arrange themselves to form a first domain 515 of a first phase made of the first polymer blocks 510a, a second domain 525 of a second phase made of the second polymer blocks 520, and a third domain 515b of a first phase made of the third polymer blocks 510b as shown in FIG. 5B. Triblock polymer molecules 500 can arrange themselves to form multiple repeat domains 525, 515 (containing both 515a and 515b), thereby forming a continuous nanostructured block copolymer 530, as shown in FIG. 5C. The sizes of the domains can be adjusted by adjusting the molecular weights of each of the polymer blocks.

In one arrangement the first and third polymer domains 515a, 515b are ionically conductive, and the second polymer domain 525 provides mechanical strength to the nanostructured block copolymer. In another arrangement, the second polymer domain 525 is ionically conductive, and the first and third polymer domains 515 provide a structural framework.

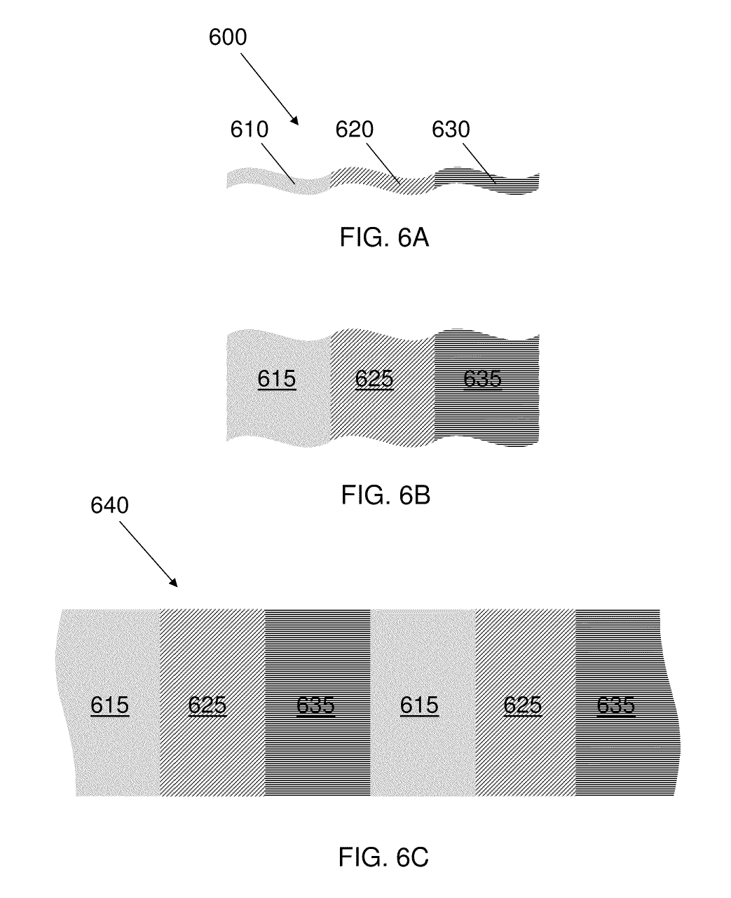

FIG. 6A is a simplified illustration of another exemplary triblock polymer molecule 600 that has a first polymer block 610, a second polymer block 620, and a third polymer block 630, different from either of the other two polymer blocks, all covalently bonded together. In one arrangement the first polymer block 610, the second polymer block 620, and the third copolymer block 630 are linear polymer blocks. In another arrangement, either some or all polymer blocks 610, 620, 630 have a comb (or branched) structure. In one arrangement, no polymer block is cross-linked. In another arrangement, one polymer block is cross-linked. In yet another arrangement, two polymer blocks are cross-linked. In yet another arrangement, all polymer blocks are cross-linked.

Multiple triblock polymer molecules 600 can arrange themselves to form a first domain 615 of a first phase made of the first polymer blocks 610a, a second domain 625 of a second phase made of the second polymer blocks 620, and a third domain 635 of a third phase made of the third polymer blocks 630 as shown in FIG. 6B. Triblock polymer molecules 600 can arrange themselves to form multiple repeat domains, thereby forming a continuous nanostructured block copolymer 640, as shown in FIG. 6C. The sizes of the domains can be adjusted by adjusting the molecular weights of each of the polymer blocks.

In one arrangement the first polymer domains 615 are ionically conductive, and the second polymer domains 625 provide mechanical strength to the nanostructured block copolymer. The third polymer domains 635 provides an additional functionality that may improve mechanical strength, ionic conductivity, chemical or electrochemical stability, may make the material easier to process, or may provide some other desirable property to the block copolymer. In other arrangements, the individual domains can exchange roles.

Choosing appropriate polymers for the block copolymers described above is important in order to achieve desired electrolyte properties. In one embodiment, the conductive polymer (1) exhibits ionic conductivity of at least 10⁻⁵ Scm⁻¹ at electrochemical cell operating temperatures when combined with an appropriate salt(s), such as lithium salt(s); (2) is chemically stable against such salt(s); and (3) is thermally stable at electrochemical cell operating temperatures. In one embodiment, the structural material has a modulus in excess of 1×10⁵ Pa at electrochemical cell operating temperatures. In one embodiment, the third polymer (1) is rubbery; and (2) has a glass transition temperature lower than operating and processing temperatures. It is useful if all materials are mutually immiscible.

In one embodiment of the invention, the conductive phase can be made of a linear or branched polymer. Conductive linear or branched polymers that can be used in the conductive phase include, but are not limited to, polyethers, polyamines, polyimides, polyamides, alkyl carbonates, polynitriles, and combinations thereof. The conductive linear or branched polymers can also be used in combination with polysiloxanes, polyphosphazines, polyolefins, and/or polydienes to form the conductive phase.

In another exemplary embodiment, the conductive phase is made of comb (or branched)polymers that have a backbone and pendant groups. Backbones that can be used in these polymers include, but are not limited to, polysiloxanes, polyphosphazines, polyethers, polydienes, polyolefins, polyacrylates, polymethacrylates, and combinations thereof. Pendants that can be used include, but are not limited to, oligoethers, substituted oligoethers, nitrile groups, sulfones, thiols, polyethers, polyamines, polyimides, polyamides, alkyl carbonates, polynitriles, other polar groups, and combinations thereof.

Further details about polymers that can be used in the conductive phase can be found in International Patent Application Number PCT/US09/45356, filed May 27, 2009, International Patent Application Number PCT/US09/54709, filed Aug. 22, 2009, International Patent Application Number PCT/US10/21065, filed Jan. 14, 2010, International Patent Application Number PCT/US10/21070, filed Jan. 14, 2010, U.S. International Patent Application Number PCT/US10/25680, filed Feb. 26, 2009, and U.S. International Patent Application Number PCT/US10/25690, filed Feb. 26, 2009, all of which are included by reference herein.

There are no particular restrictions on the electrolyte salt that can be used in the block copolymer electrolytes. Any electrolyte salt that includes the ion identified as the most desirable charge carrier for the application can be used. It is especially useful to use electrolyte salts that have a large dissociation constant within the polymer electrolyte.

Suitable examples include alkali metal salts, such as Li salts. Examples of useful Li salts include, but are not limited to, LiPF₆, LiN(CF₃SO₂)₂, Li(CF₃SO₂)₃C, LiN(SO₂CF₂CF₃)₂, LiB(C₂O₄)₂, B₁₂₋ₓ, B₁₂F₁₂, and mixtures thereof.

In one embodiment of the invention, single ion conductors can be used with electrolyte salts or instead of electrolyte salts. Examples of single ion conductors include, but are not limited to sulfonamide salts, boron based salts, and sulfates groups.

In one embodiment of the invention, the structural phase can be made of polymers such as polystyrene, hydrogenated polystyrene, polymethacrylate, poly(methyl methacrylate), polyvinylpyridine, polyvinylcyclohexane, polyimide, polyamide, polypropylene, polyolefins, poly(t-butyl vinyl ether), poly(cyclohexyl methacrylate), poly(cyclohexyl vinyl ether), poly(t-butyl vinyl ether), polyethylene, fluorocarbons, such as polyvinylidene fluoride, or copolymers that contain styrene, methacrylate, or vinylpyridine.

Additional species can be added to nanostructured block copolymer electrolytes to enhance the ionic conductivity, to enhance the mechanical properties, or to enhance any other properties that may be desirable.

The ionic conductivity of nanostructured block copolymer electrolyte materials can be improved by including one or more additives in the ionically conductive phase. An additive can improve ionic conductivity by lowering the degree of crystallinity, lowering the melting temperature, lowering the glass transition temperature, increasing chain mobility, or any combination of these. A high dielectric additive can aid dissociation of the salt, increasing the number of Li+ ions available for ion transport, and reducing the bulky Li+[salt] complexes. Additives that weaken the interaction between Li+ and PEO chains/anions, thereby making it easier for Li+ ions to diffuse, may be included in the conductive phase. The additives that enhance ionic conductivity can be broadly classified in the following categories: low molecular weight conductive polymers, ceramic particles, room temp ionic liquids (RTILs), high dielectric organic plasticizers, and Lewis acids.

Other additives can be used in the polymer electrolytes described herein. For example, additives that help with overcharge protection, provide stable SEI (solid electrolyte interface) layers, and/or improve electrochemical stability can be used. Such additives are well known to people with ordinary skill in the art. Additives that make the polymers easier to process, such as plasticizers, can also be used.

Further details about block copolymer electrolytes are described in U.S. patent application Ser. No. 12/225,934, filed Oct. 1, 2008, U.S. patent application Ser. No. 12/271,1828, filed Nov. 14, 2008, and International Patent Application Number PCT/US09/31356, filed Jan. 16, 2009, all of which are included by reference herein.

The embodiments of the invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. A electrode comprising:
a sulfur-based active material;
an electronically conducting agent; and
a solid polymer electrolyte;
wherein the active material, the conducting agent, and the electrolyte are all mixed together to form an electrode active film.

2. The electrode of claim 1 wherein the electrode active film comprises between about 50% and 80% sulfur.

3. The electrode of claim 1 wherein the cathode electrode is adapted for use with an anode electrode comprising Li metal.

4. The electrode of claim 1, further comprising a current collector adjacent the electrode active film.

5. The electrode of claim 1 wherein the cathode contains no fluorinated polymers.

6. The electrode of claim 1 wherein the solid polymer electrolyte comprises a block copolymer.

7. The electrode of claim 6 wherein the solid polymer electrolyte further comprises at least one lithium salt.

8. The electrode of claim 6 wherein the block copolymer is either a diblock copolymer or a triblock copolymer.

9. The electrode of claim 8 wherein a first block of the block copolymer is ionically conductive and is selected from the group consisting of polyethers, polyamines, polyimides, polyamides, alkyl carbonates, polynitriles, polysiloxanes, polyphosphazines, polyolefins, polydienes, and combinations thereof.

10. The electrode of claim 8 wherein a first block of the block copolymer comprises an ionically-conductive comb polymer, which comb polymer comprises a backbone and pendant groups.

11. The electrode of claim 10 wherein the backbone comprises one or more selected from the group consisting of polysiloxanes, polyphosphazines, polyethers, polydienes, polyolefins, polyacrylates, polymethacrylates, and combinations thereof.

12. The electrode of claim 10 wherein the pendants comprise one or more selected from the group consisting of oligoethers, substituted oligoethers, nitrile groups, sulfones, thiols, polyethers, polyamines, polyimides, polyamides, alkyl carbonates, polynitriles, other polar groups, and combinations thereof.

13. The electrode of claim 8 wherein a second block of the block copolymer is selected from the group consisting of polystyrene, hydrogenated polystyrene, polymethacrylate, poly(methyl methacrylate), polyvinylpyridine, polyvinylcyclohexane, polyimide, polyamide, polypropylene, polyolefins, poly(t-butyl vinyl ether), poly(cyclohexyl methacrylate), poly(cyclohexyl vinyl ether), poly(t-butyl vinyl ether), polyethylene, fluorocarbons, polyvinylidene fluoride, and copolymers that contain styrene, methacrylate, and/or vinylpyridine.

14. An electrochemical cell comprising
a cathode comprising:
a sulfur-based active material;
an electronically conducting agent; and
a first solid polymer electrolyte;
wherein the active material, the conducting agent, and the electrolyte are all mixed together to form an electrode active film;
an anode comprising lithium; and
a second solid polymer electrolyte positioned between the cathode and the anode and providing ionic communication therebetween.

15. The cell of claim 14 wherein the anode comprises lithium or sodium.

16. The cell of claim 14 wherein the anode comprises a lithium metal film.

17. The cell of claim 14 wherein the cathode electrode comprises between about 50% and 80% sulfur.

18. The cell of claim 14 wherein the first solid polymer electrolyte and the second solid polymer electrolyte are the same.

19. The cell of claim 14 wherein the cathode contains no fluorinated polymers.
